(19) United States
(12) Patent Application Publication
(10) Pub. No.: US 2014/0352376 A1
(43) Pub. Date: Dec. 4, 2014

(54) FERTILIZER COMPOSITIONS METHODS OF MAKING AND USING SAME

(71) Applicant: BiOWiSH Technologies, Inc., Cincinnati, OH (US)

(72) Inventor: Richard S. Carpenter, West Chester, OH (US)

(73) Assignee: BiOWiSH Technologies, Inc., Cincinnati, OH (US)

(21) Appl. No.: 14/289,361

(22) Filed: May 28, 2014

Related U.S. Application Data
(60) Provisional application No. 61/828,147, filed on May 28, 2013.

(51) Int. Cl. C05B 17/00

(52) U.S. Cl. CPC C05B 17/00
USPC 71/6

(57) ABSTRACT

The present invention relates mixed bacterial compositions for their use in fertilizer applications.

### RELATED APPLICATIONS

This application claims priority to and benefit of provisional application U.S. Ser. No. 61/828,147 filed on May 28, 2013, the contents of which are herein incorporated by reference in its entirety.

### FIELD OF THE INVENTION

The present invention relates to solid fertilizer compositions comprising bioactive agents, in particular microorganisms and the methods of making same.

### BACKGROUND OF THE INVENTION

Microbial based crop treatments are a rapidly growing segment in the agronomy market, particularly as components of, or supplements to traditional fertilizers. In fertilizer applications it is desirable to add the microbial treatment into existing agricultural products in order to simplify use and improve customer adaptation and dosage compliance. However, the majority of microbial crop treatment products are marketed as supplements, requiring a separate application, process or use step. For example, Agrinos' HYT™ products are recommended to be applied either via spray-on or through irrigation systems. SERENADE® is recommended for foliar spray applications as a disease control measure. Novozymes' Biologicals JumpStart® is to be applied to crop seeds prior to planting. The recommended application for Biota Max™, marketed by Custom Bio, is to dissolve a tablet in water and spray the soil around the base of plants. OHHIRA'S PROBIOTICS BTO is injected into soil as a solution mixed with molasses. All of these products require separate application from traditional fertilizer usage, increasing complexity and cost to the end user.

Similarly, the art anticipates microbial use as a supplement to traditional fertilizers. Tzeng and Huang (US 2008/0152684A1) disclose the use of Bacillus subtilis WG6-14 for protecting plants against plant pathogens or enhancing plant growth. In field trials with this material, plants are sprayed with a broth culture which comprises an additional step to the application of fertilizer. US2003/0045428A1 teaches the application of spores or live cells of Bacillus laterosorus strain CM-3 for increasing the yields of grain crops. The spores are applied to crops as an aqueous suspension obtained directly from the fermentation of the CM-3 microorganism or via re-suspension of a spray- or freeze dried version. The use of microbial supplements, added as separate products from traditional fertilizers, introduces complexity in the target applications of agronomy, reducing their attractiveness and compromising customer adaptation and dosage compliance.

A number of approaches have been investigated for incorporating microbes, or microbial compositions into fertilizer compositions. Wendt (US 2009/0126432 A1) describes preparation of NPK fertilizers containing Bacillus spores, decontaminated manure, and humic acid. The decontaminated manure and humic acid are mixed as dry ingredients with Ca(H₂PO₄)₂, KCl, and Urea then fed into an agglomerator. A 50% aqueous suspension of the Bacillus spores is sprayed-on in the agglomerator and the resulting moistened ingredients formed into prills in a revolving drying tunnel. US 2011/0000268A1 teaches coating a fertilizer or animal feed particle with 5-35 dry wt % biomass solid particles with a particle size below 400 microns and an oil or wax based dispersant. Porubcan (U.S. Pat. No. 7,442,224B2, U.S. Pat. No. 7,044,994B2, and U.S. Pat. No. 6,878,179B2) discloses fertilizer compositions comprising decontaminated manure and Bacillus spores in combination with a humic acid derivative and, optionally, one or more of N, P, K compounds. The dry ingredients are first mixed then ground to 100-150 mesh. The Bacillus spores are sprayed-on and the resulting product prilled via a rotating drier. In these examples, an additional prill or particle forming step is required to produce the finished product. It is desirable to use an existing particle already present in the fertilizer, e.g. Urea, Diammonium Phosphate, Potassium Chloride, or a filler particle.

Westbrook and Warren (US 2007/0131009 A1) disclose coated granular compositions comprising a soluble coating agent with a plurality of microbes dispersed therein. The granular substrate may be selected from chemical N—P—K ingredients and the coating agent may comprise any of a number of water soluble inorganic or organic materials. It is not clear from this art how the coating is applied or if there is a preferred set of process conditions for obtaining an optimum coating.

There remains a need, therefore, to create microbe-containing particles wherein a component of an existing in-market formulation can be used as the carrier for the microbes or microbial compositions and the viability of the microorganisms is preserved. There is an unmet need for such particles in the agronomy market.

### SUMMARY OF THE INVENTION

In various aspects the invention provides fertilizer compositions containing a mixture of microorganisms that are useful in promoting the health and vigor of plants.

In various aspects the invention provides a fertilizer composition having a specified NPK rating. The fertilizer composition includes a carrier system for delivering a bacterial mix to crops. The carrier system is coated with a bacteria mixture containing bacteria from the genus Bacillus, Pseuodomonas, and Streptomyces. The bacteria mixture is coated on the carrier system in an amount between 10⁶ to 10¹¹ colony forming units (CFU) per gram of carrier.

The Bacillus bacteria include Bacillus from the species Bacillus subtilis, Bacillus racemilacticus, Bacillus licheniformis, Bacillus amyloliquefaciens, Bacillus cereus, and Bacillus pumilus. The Pseuodomonas bacteria is preferably Pseudomonas putida.

The Streptomyces bacteria are Streptomyces griseoviridis and Streptoverticillium griseocarnium. Preferably, the bacteria mixture is Bacillus subtilis, Bacillus racemilacticus, Bacillus licheniformis, Bacillus amyloliquefaciens, Bacillus cereus, Bacillus pumilus Pseudomonas putida, Streptomyces griseoviridis, and Streptoverticillium griseocarnium. In some aspects the ratio of Bacillus to Pseudomonas and Streptomyces is at least 2:1 (wt/wt).

In various aspects the carrier system is a dried powder, granulate or porous media. Preferably, the dried powder, granulate or porous media has a mean particle size between about 100 and 1000 microns. The carrier system is an inert solid. Inert solids include filler. The inert solid is organic or soluble. For example, the organic inert solid is rice bran, soy bran, soy meal, soy flour, wheat bran, bone meal, fish meal, or guano. Soluble inert carriers include, for example urea, dextrose, DAP, or MAP.

In various aspects, the composition further includes a drying agent such as diatomaceous earth or calcium sulfate, or Zeolite, or Bentonite. In other aspects, the composition has an NPK rating of 3-4-0.

In yet another aspect the fertilizer composition further includes a dispersing agent such as, for example, calcium lignosulfonate.

Also provided by the invention are methods of manufacturing the fertilizer compositions of the invention. Fertilizer compositions are prepared by coating a carrier with a bacterial solution comprising a bacteria mixture containing Bacillus, Pseuodomonas, and Streptomyces to produce a bacteria coated carrier; and drying the coated carrier. The bacteria mixture is coated on the carrier in an amount between 10⁶ to 10¹¹ colony forming units (CFU) per gram of carrier. Alternatively, the concentration of the bacteria mixture is about 0.001% to 10% (w/w) of the carrier.

The Bacillus bacteria include Bacillus from the species Bacillus subtilis, Bacillus racemilacticus, Bacillus licheniformis, Bacillus amyloliquefaciens, Bacillus cereus, and Bacillus pumilus. The Pseuodomonas bacteria is preferably Pseudomonas putida.

The Streptomyces bacteria are Streptomyces griseoviridis and Streptoverticillium griseocarnium. Preferably, the bacteria mixture is Bacillus subtilis, Bacillus racemilacticus, Bacillus licheniformis, Bacillus amyloliquefaciens, Bacillus cereus, Bacillus pumilus Pseudomonas putida, Streptomyces griseoviridis, and Streptoverticillium griseocarnium. In some aspects the ratio of Bacillus to Pseudomonas and Streptomyces is at least 2:1 (wt/wt).

In various aspects the carrier system is a dried powder, granulate or porous media. Preferably, the dried powder, granulate or porous media has a mean particle size between about 100 and 1000 microns. In some aspects the carrier has a specific gravity between about 0.3 and 1.5 g/cm³.

The carrier system is an inert solid. Inert solids include filler. The inert solid is organic or soluble. For example, the organic inert solid is rice bran, soy bran, soy meal, soy flour, wheat bran, bone meal, fish meal, or guano. Soluble inert carriers include, for example urea, dextrose, DAP, or MAP.

Optionally, the method includes coating the bacterial coated carrier with a drying agent prior drying. The drying agent is for example, diatomaceous earth or calcium sulfate, or Zeolite, or Bentonite. The drying agent is added at a level of 0.1 to 5 wt. % of the substrate. Optionally, the method further includes adding a dispersing agent to the composition such as, for example, calcium lignosulfonate. In other aspects, the composition has an NPK rating of 3-4-0.

The invention further provides a method for fertilizing crops, by contacting the crops with the compositions according to the inventions. Optionally, the method further includes mixing the composition of the invention with at least one additional fertilizer ingredient prior to contacting the crops. The crops for example are rice, corn, soy beans, tomatoes, lettuce, barley, wheat, legumes, and grass.

Unless otherwise defined, all technical and scientific terms used herein have the same meaning as commonly understood by one of ordinary skill in the art to which this invention pertains. Although methods and materials similar or equivalent to those described herein can be used in the practice of the present invention, suitable methods and materials are described below. All publications, patent applications, patents, and other references mentioned herein are expressly incorporated by reference in their entirety. In cases of conflict, the present specification, including definitions, will control. In addition, the materials, methods, and examples described herein are illustrative only and are not intended to be limiting.

Other features and advantages of the invention will be apparent from and encompassed by the following detailed description and claims.

### BRIEF DESCRIPTION OF THE DRAWINGS

FIG. 1 is a digital micrograph of a solid organic particle (Nutri-Pel® Bio Solid) coated with Sealmaster® P30L starch and the dry microbial mixture of the invention. It is clear from this photograph that the microbial particles sit on the surface of the solid organic particle. Further, this photograph demonstrates that the microbial particles are larger than the adhesive polymer film thickness and, therefore, cannot be part of the film as is taught in US 2007/0131009 A1 (Westbrook and Warren).

FIG. 2 is a digital micrograph of 46-0-0 Urea particles coated with Sealmaster® P30L and a powdered microbial composition of particle size less than about 200 microns.

FIG. 3 shows CO₂ evolution of Nutri-Pel BioSolids coated with the mixed microorganism composition of the present invention.

FIG. 4 shows O₂ evolution of Nutri-Pel BioSolids coated with the mixed microorganism composition of the present invention.

FIG. 5 shows the cumulative CO₂ evolution of Nutri-Pel BioSolids coated with the mixed microorganism composition of the present invention.

FIG. 6 shows the cumulative O₂ consumption of Nutri-Pel BioSolids coated with the mixed microorganism composition of the present invention.

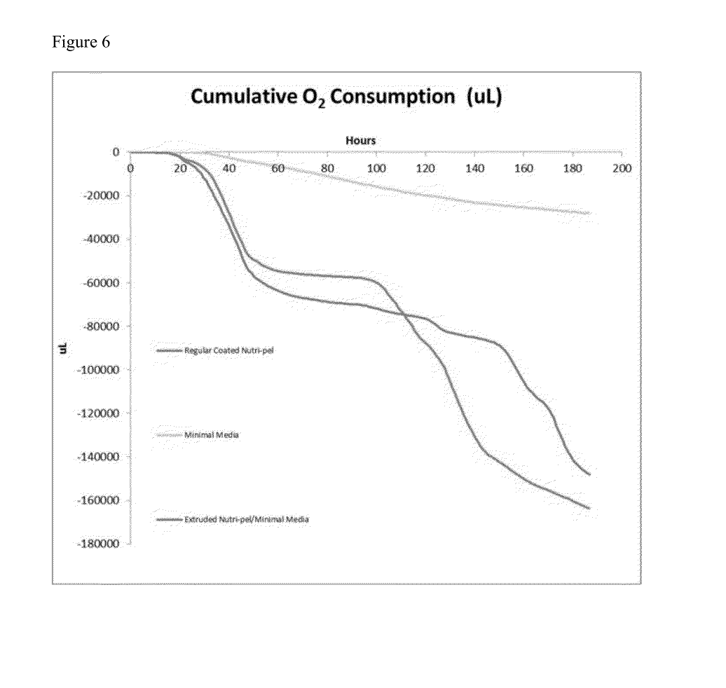

FIG. 7 shows the total NO₃ increase of the Urea coated with the mixed microorganism composition of the present invention.

### DETAILED DESCRIPTION OF THE INVENTION

The invention provides fertilizer compositions which enhance plant yields and/or reduce nitrogen requirements. Additionally, the compositions of the present invention also provide plants with higher Brix index, antioxidant levels, and chlorophyll content. The invention further provides a method of producing the fertilizer product in a solid form. The composition and methods are applicable to any microbial-based treatment designed for agronomy or agricultural applications.

The fertilizer compositions of the invention contain a complex mixture of microorganisms. The microorganisms promote improved plant health and higher yield per acre.

The microorganisms according to the invention may be viable or non-viable. In case the microorganisms are non-viable, they have to be substantially structurally intact, meaning that these non-viable micro-organisms are still sufficiently intact to avoid or delay disintegration during application thereby enabling the interaction of (conserved structures of) the non-viable micro-organisms with the local soil ecology, particularly the soil microbial community.

The term “microbial, bacteria” or “microbes” as used herein, refers to microorganisms that confer a benefit. The microbes according to the invention may be viable or non-viable. The non-viable microbes are metabolically-active. By “metabolically-active” is meant that they exhibit at least some residual enzyme, or secondary metabolite activity characteristic to that type of microbe.

By the term non-viable” as used herein is meant a population of bacteria that is not capable of replicating under any known conditions. However, it is to be understood that due to normal biological variations in a population, a small percentage of the population (i.e. 5% or less) may still be viable and thus capable of replication under suitable growing conditions in a population which is otherwise defined as non-viable.

By the term “viable bacteria” as used herein is meant a population of bacteria that is capable of replicating under suitable conditions under which replication is possible. A population of bacteria that does not fulfill the definition of “non-viable” (as given above) is considered to be “viable”.

By the term “bioactive component” as used herein is meant a component which has a physiological effect upon plants when applied in adequate amounts.

Preferred microorganisms are derived from the genus Bacillus, Pseuodomonas, and Streptomyces. The Bacillus bacteria are for example Bacillus subtilis, Bacillus racemilacticus, Bacillus licheniformis, Bacillus amyloliquefaciens, Bacillus cereus, and Bacillus pumilus. The Pseuodomonas bacteria is preferably Pseudomonas putida. The Streptomyces bacteria are Streptomyces griseoviridis, and Streptoverticillium griseocarnium.

A preferred composition of the present invention comprises a mixture of Bacillus subtilis, Bacillus racemilacticus, Bacillus licheniformis, Bacillus amyloliquefaciens, Bacillus cereus, Bacillus pumilus, Pseudomonas putida, Streptomyces griseoviridis, and Streptoverticillium griseocarnium. In some aspects the ratio of Bacillus to the combination of Pseudomonas and Streptomyces is at least 2:1 wt/wt. Preferably the ratio is 3:1 wt/wt. Most preferably 4:1 wt/wt. In some aspects the mixture has a microbial activity between 10⁸ and 10¹⁰ CFU/g.

A major aspect of the present invention involves the production of fertilizer products in solid form. One particularly preferred solid fertilizer product of the invention is in the form of a solid carrier coated of microorganisms. The term carrier, carrier system or particles are used herein interchangeably.

Although it is possible to achieve the benefits of the present invention by simply admixing these various ingredients, or by admixing only the N—P—K fertilizer and the microorganisms, it is an object of the present invention to provide ready-to-use fertilizer products containing both N—P—K particles and microorganism. In one preferred embodiment the fertilizer products comprise particles coated with the microbial mix of the present invention. The particles have a roughly spherical shape with diameters ranging from about 1 to about 20 millimeters, more preferably from about 2 to about 8 millimeters, and a specific gravity of between 0.5 and 1 g/cm³. Such products minimize disruption and cost to the end-user (e.g. commercial farming concerns). In another preferred embodiment the fertilizer products comprise particles with a size range between 50 and 200 microns and a specific gravity of between 0.3 and 1 g/cm³. In yet another preferred embodiment the fertilizer products comprise particles with a size range between 200 and 1000 microns and a specific gravity of between 0.5 and 1.5 g/cm³.

The carrier particles may be organic or inorganic. Carrier particles of the invention are prepared using means known within the art. One preferred method involves the formation of solid carriers from melts of various salts in a revolving drum drier that produces round or oval particles. Preferred salts for the preparation of such solid particles are urea, di-ammonium phosphate, mono-ammonium phosphate, and potassium chloride. Filler particles are commonly used in fertilizer formulations and are preferred solid substrates in this invention. Common fillers include limestone, pelletized limestone (Pel-Lime), volcanic ash, clays (e.g. Kaoline), activated carbon and dried, decontaminated manure. Another preferred method involves grinding and sieving organic particles to achieve a specific size range. Preferred organic particles include rice bran, soybran, soy flour, soy meal, wheat bran, bone meal, fish meal, or guano.

Other carrier particles include for example, a chemical N—P—K ingredient, a plant nutrient, a humate or a vitamin. N ingredients include urea, ammonium sulfate, ammonium nitrate, ammonium phosphate, calcium nitrate, potassium nitrate, sodium nitrate. P ingredients include ammonium phosphate, superphosphate, Ca(H₂PO4)₂, tricalcium phosphate, phosphate salts of sodium or potassium, including orthophosphate salts. K ingredients include KCl, potassium sulfate, potassium nitrate, and phosphate salts of potassium, including orthophosphate salts.

Particularly preferred carrier particles are prepared from the recovered processed sludge of municipal waste treatment (see for example EPA530-R-99-009, September, 1999). Among these materials Nutri-Pel® Bio Solid 4-4-0-2Fe is most preferred. This material is obtained from activated sewage sludge (91.5%) and has the following composition: 4% total Nitrogen (0.75% water soluble Nitrogen and 3.75% water insoluble Nitrogen), 4% available phosphate as P₂O₅, 2% iron, 3.2% Calcium, 1.4% Sulfur, 4-5% moisture, pH 7.0, and specific gravity of about 0.8 g/cm³. The material is roughly spherical in shape with an average particle size of about 2 to about 6 millimeters in diameter.

In another preferred embodiment the dried microbial mixtures of the present invention are admixed with solid carriers having particle size less than about 120 microns to provide a dried, dispersible or soluble powder suitable for admix into irrigation and fertilizer spraying systems. Carriers include, but are not limited to, soy, rice, and wheat bran; soy, rice, and wheat flour; sugars such as dextrose, fructose, or sucrose; bone and fish meal; guano and other dried manures; clays such as bentonite or kaolin; zeolites; activated carbon or biochar; or ground waste agricultural products such as peanut shells, corn Stover, corn cob. A preferred composition according to the present invention comprises the dried microbial mixture combined with soy flour and rice bran in such a way as to give a final NPK rating of 3-4-0, plus a dispersing agent such as calcium or sodium lignosulfonate to enable delivery through irrigation and fertilizer spray systems. In another preferred composition, the dried microbial mixture is combined with dextrose or maltodextrin and di-ammonium phosphate to provide a fully water soluble product with an NPK rating of 3-4-0.

The microorganism mixture may be prepared by any of the common methods known in the art. A preferred method involves submerged liquid fermentation of the individual strains, collection of the fermentation broth and mixing to give a liquid product with total bacterial activity of about 1×10⁹ CFU/g. In another preferred method for producing the mixtures of the present invention a starter culture comprising all of the microorganisms is fermented in two stages; one liquid fermentation followed by solid substrate fermentation on rice, soy and nutrients. Post fermentation, water is removed and the product is dried to a moisture level below 5% and a solid dry mass of at least 50 wt. %. The product is then ground to an average particle size of less than about 750 microns. Preferred are carrier particle sizes are about 100-1000 microns. In some aspects the carrier particle is less than about 200 microns. In other aspects the carrier particle sizes between about 10 and 180 microns. Admixes are then combined with the premix in a mixing process to create further product and formula differentiation. When produced via this method the total bacterial count is typically between 1×10⁵ and 1×10⁶ CFU/g.

When produced via submerged liquid fermentation the resulting liquid product is amenable to direct spray on to certain particles. In particular, the liquid product can be sprayed directly on to Urea, DA, MAP, Biochar, activated carbon, or the Nutri-Pel® Bio Solids at a level between 0.01 and 5 wt. % using any number of traditional mixing/spraying systems known in the art including drum mixers, paddle mixers, screw mixers, spray-dryers, etc. A particularly preferred mixer of the present invention is the OptimaBlend™ fluidizing paddle blender from Eirich. Another preferred mixer of the present invention is the Rollo-mixer® batch mixer from Continental Products Corp. The bioSolids are sufficiently porous that when loaded with up to 5% by weight of liquid, the product after mixing is dry and free flowing and no additional drying agent is required. Higher loadings are possible but require addition of an appropriate drying agent. When coating Urea and DAP a drying agent is generally required. Preferred drying aids are diatomaceous earth, zeolites, anhydrous sodium sulfate, anhydrous calcium sulfate, biochar or activated carbon, and clay or mixtures thereof.

When produced as a solid product, in order to attach the dried microorganisms to the solid particles of the present invention a binding or coating agent is required. Preferred binders include water soluble, or water dispersable polmers such as starch, chitosan, alginate, polyvinyl alcohol, polyvinyl acetate, ethylene vinyl acetate, polyethylene glycol or mixtures thereof. Typically, the polymers are dissolved or dispersed in water, at a pH consistent with each polymer's solubility profile, at levels from 0.1 to about 50 wt %. The resulting aqueous binder solutions exhibit viscosities ranging from about 100 to about 30,000 centipoise and are added to the solid particles of the invention. A particularly preferred binder of the present invention is a high molecular weight starch supplied under the trade name SEALMASTER® P30L by Grain Processing Corporation.

To achieve a dry, free flowing particle it may be necessary, in some applications, to dust the coated particles, after addition of the powdered microorganisms, with a flow aid. Flow aides are added at levels of about 0.15 to 5% (w/w). Flow aides are added at levels of about 0.1 to 5% (w/w). Flow aides can also be drying agents. Any of the powdered flow aids typically used in the particle coating industry are suitable for use in the present invention. Preferred are powders that also help keep the particle dry and crisp in humid storage conditions. Examples include diatomaceous earth, kaolin, bentonite, zeolites, anhydrous calcium sulfate, anhydrous sodium sulfate, calcium chloride or mixtures thereof

Method of manufacturing a fertilizer composition are also included in the invention. The fertilizer composition are manufacture by, coating a carrier with a bacterial solution comprising the bacterial mixtures according the invention to produce a bacteria coated carrier; and drying the coated carrier.

A better understanding of the present invention may be given with the following examples which are set forth to illustrate, but are not to be construed to limit the present invention.

### EXAMPLES

### Example 1

### Preparation of the Liquid Microbial Species

The microbes of the present invention can be grown using standard submerged liquid fermentation processes known in the art.

Individual starter cultures of Bacillus subtilis, Bacillus racemilacticus, Bacillus licheniformis, Bacillus amyloliquefaciens, Bacillus cereus, Bacillus pumilus, Pseudomonas putida, Streptoverticillium griseocarnium, and Streptomyces griseoveridis were grown according to the following general protocol and adapted as required for each separate organism: 2 grams Nutrient Broth, 2 grams AmberFerm (yeast extract) and 4 grams Maltodextrin were added to a 250 ml Erlenmeyer flask. 100 mls distilled, deionized water were added and the flask stirred until all dry ingredients dissolved. The flask was covered and placed for 30 min in an Autoclave operating at 121° C. and 15 psi. After cooling, the flask was inoculated with 1 ml of one of the pure microbial strains. The flask was sealed and placed on an orbital shaker at 30° C. Cultures were allowed to grow for 3-5 days. This procedure was repeated for each of the individual microorganisms. In this way starter cultures of Bacillus subtilis, Bacillus racemilacticus, Bacillus licheniformis, Bacillus amyloliquefaciens, Bacillus cereus, Bacillus pumilus, Pseudomonas putida, Streptoverticillium griseocarnium, and Streptomyces griseoveridis were prepared.

Larger cultures were prepared by adding 18 grams Nutrient Broth, 18 grams AmberFerm, and 36 grams Maltodextrin to 1 liter flasks with 900 mls distilled, deionized water. The flasks were sealed and sterilized as above. After cooling, 100 mls of the microbial media from the 250 ml Erlenmeyer flasks were added. The 1 liter flasks were sealed, placed on an orbital shaker, and allowed to grow out for another 3-5 days at 30° C.

In the final grow-out phase before introduction to the fermenter, the cultures from the 1 liter flasks were transferred under sterile conditions to sterilized 6 liter vessels and fermentation continued at 30° C. with aeration until stationary phase was achieved. The contents of each 6 liter culture flask was transferred to individual fermenters which were also charged with a sterilized growth media made from 1 part yeast extract and 2 parts dextrose. The individual fermenters were run under aerobic conditions operating at pH 7.0 and the temperature optimum for each species:

| Microbe | Temperature Optimum |
|---|---|
| Bacillus subtilis | 35° C. |
| Bacillus amyloliquefaciens | 30° C. |
| Bacillus licheniformis | 37° C. |
| Bacillus racemilacticus | 30° C. |
| Bacillus cereus | 30° C. |
| Bacillus pumilus | 30° C. |
| Pseudomonas putida | 30° C. |
| Streptoverticillium griseocarnium | 30° C. |
| Streptomyces griseoveridis | 30° C. |

Each fermenter was run until cell density reached 10¹¹ CFU/ml, on average. The individual fermenters were then emptied into a large, stirred holding tank at 25-27° C.

### Example 2

### Preparation of the Dried Microbial Species

The mixed liquid microbial composition from Example 1 was filtered, centrifuged then vacuum dried until moisture dropped below 5%. The resulting dried microbial product was ground to an average particle size of 100 microns. The final microbial activity of the dried, ground product was 10⁹-10¹⁰ CFU/g.

In an alternative procedure the individual liquid fermentations from Example 1 were each filtered, centrifuged and vacuum dried until moisture dropped below 5%. The resulting dried microbial products were then ground to an average particle size of 100 microns. After grinding the individual dried microbial products were combined in equal proportion to give a final mixed microbial composition with activity between 10⁹ and 10¹⁰ CFU/g.

### Example 3

### Formulation of Coated Particles Using the Liquid Microbial Product from Example 1

a. BioSolids

Filler particles used by the fertilizer industry (designated 4-4-0-2Fe and referred to as Nutri-Pel® Bio-solid) are used as carrier particles. 500 pounds of Nutri-Pel® particles are loaded into a Continental Rollo-Mixer MK IX, Model No. 31-15/90s (Continental Products Corporation) operating at 90 hertz. 2.75 pounds of the mixed microbial liquid composition from Example 1 are sprayed onto the Nutri-Pel® bed with mixing. After spraying, the particles are allowed to mix until dry to the touch. Microbial activity, determined by dosing a sample of the coated particle into buffer followed by serial dilution and plating, shows activity of 10⁹ CFU/g.

b. Urea

500 pounds of Urea (46-0-0 from Prairie Creek Terminal Service, Elwood, Ill.) are loaded into a Continental Rollo-Mixer MK IX, Model No. 31-15/90s (Continental Products Corporation) operating at 90 hertz. 1.5 lbs of the mixed microbial liquid composition from Example 1 are sprayed onto the Urea using a fine mist nozzle. The particles are allowed to mix until visual observation confirms uniform wetting. 15 pounds of Diatomaceous Earth are then added and mixing continues until the particles are dry to the touch.

c. Diammonium Phosphate

500 pounds of Diammonium Phosphate (DAP 18-46-0 from Prairie Creek Terminal Service, Elwood, Ill.) are loaded into a Continental Rollo-Mixer MK IX, Model No. 31-15/90s (Continental Products Corporation) operating at 90 hertz. 1.5 lbs of the mixed microbial liquid composition from Example 1 are sprayed onto the DAP using a fine mist nozzle. The particles are allowed to mix until visual observation confirms uniform wetting. 15 pounds of Diatomaceous Earth are then added and mixing continues until the particles are dry to the touch.

### Example 4

### Preparation of Coated Particles Using the Dry Microbial Product from Example 2

a. BioSolids

500 pounds of Nutri-Pel® biosolid particles (4-4-0-2Fe) are loaded into a Continental Rollo-Mixer MK IX, Model No. 31-15/90s (Continental Products Corporation) operating at 90 hertz. 3 pounds of Sealmaster® P30L starch binder (from Grain Processing Corporation) are added with mixing. Mixing continues until visual observation confirms wetting of all the particles with the starch binder. 2.75 pounds of the dried microbial product composition from Example 2 are then added to the mixer. If needed to obtain a dry, free flowing particle, Diatomaceous Earth may be added and the contents mixed until the particles are dry to the touch.

b. Urea

500 pounds of Urea (46-0-0 from Prairie Creek Terminal Service, Elwood, Ill.) are loaded into a Continental Rollo-Mixer MK IX, Model No. 31-15/90s (Continental Products Corporation) operating at 90 hertz. The urea is wetted by spraying-on 2.5 pounds of water via a fine mist sprayer with mixing. The particles are allowed to mix until visual observation confirms uniform wetting. 2.5 pounds of the dried microbial product composition from Example 2 are then added to the mixer. To obtain a dry, free flowing particle, up to 15 pounds of Diatomaceous Earth are added and the contents mixed until the particles are dry to the touch.

c. Diammonium Phosphate

500 pounds of Diammonium Phosphate (DAP 18-46-0 from Prairie Creek Terminal Service, Elwood, Ill.) are loaded into a Continental Rollo-Mixer MK IX, Model No. 31-15/90s (Continental Products Corporation) operating at 90 hertz. The DAP is wetted by spraying-on 2.5 pounds of water via a fine mist sprayer with mixing. The particles are allowed to mix until visual observation confirms uniform wetting. 2.5 pounds of the dried microbial product composition from Example 2 are then added to the mixer. To obtain a dry, free flowing particle, up to 15 pounds of Diatomaceous Earth are added and the contents mixed until the particles are dry to the touch.

### Example 5

### Formulation of a Powder 3-4-0 NPK Product Comprising the Mixed Microbes of the Present Invention

Soy flour (Prolia 200-70 Cargill) with an average particle size below 100 microns is mixed in a ratio of 1:10 with Rice Bran (Riceland) that is also ground to a particle size below 100 microns. To this blend is added 1% by weight Calcium Lignosulfonate (Borrplex CA from Borregaard Lignotech) and from 0.1% to 1.0% by weight of the dried, mixed microbial composition from Example 2. The final microbial activity is between 10⁶-10⁷ CFU/g.

### Example 6

### Preparation of Coated Particles Using the Composition from Example 5

a. BioSolids

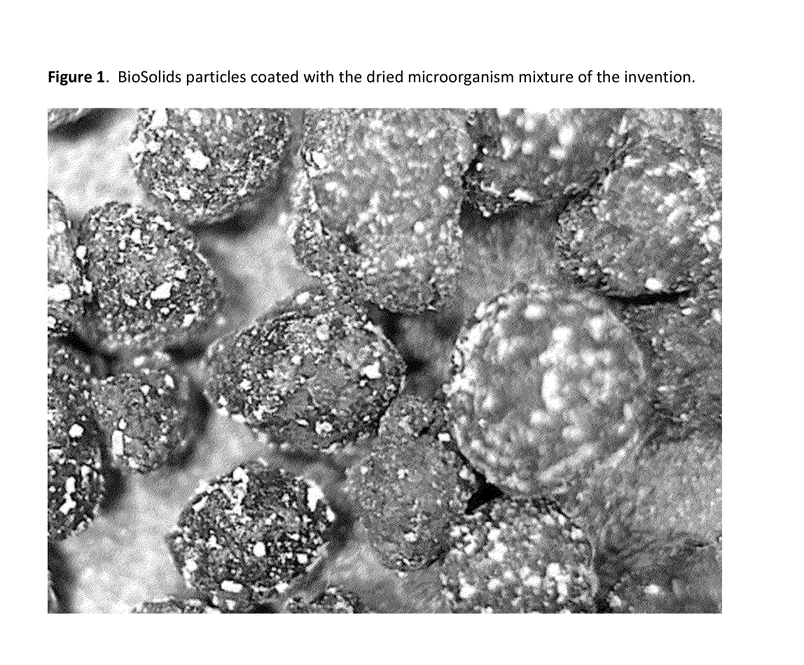

464 pounds of Nutri-Pel® biosolid particles (4-4-0-2Fe) were loaded into a Continental Rollo-Mixer MK IX, Model No. 31-15/90s (Continental Products Corporation) operating at 90 hertz. 15 pounds of Sealmaster® P30L starch binder (from Grain Processing Corporation) were added with mixing. Mixing continued until visual observation confirmed wetting of all the particles with the starch binder. 15 pounds of the dried microbial product composition from Example 5 were then added. After mixing, a dry, free flowing product was obtained. A photomicrograph of the coated particle is shown in FIG. 1.

b. Urea

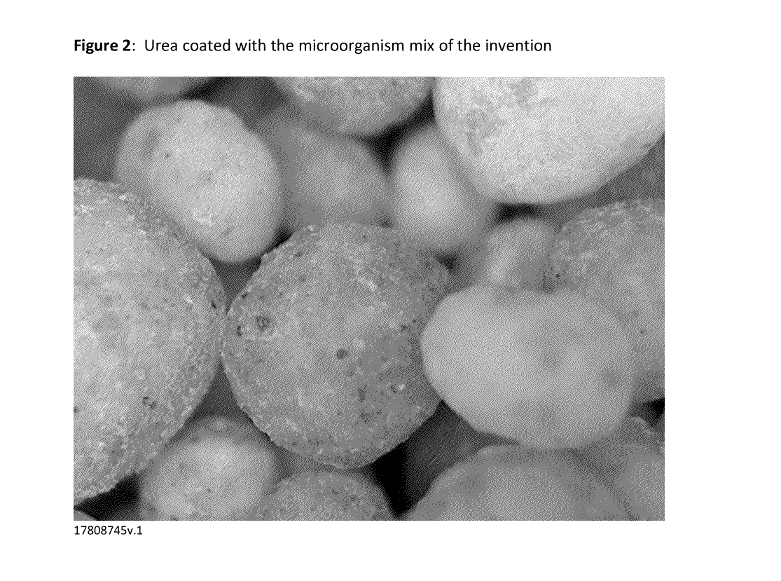

483 pounds of Urea (46-0-0 from Prairie Creek Terminal Service, Elwood, Ill.) were loaded into a Continental Rollo-Mixer MK IX, Model No. 31-15/90s (Continental Products Corporation) operating at 90 hertz. The urea was wetted by spraying-on 2.5 pounds of water via a fine mist sprayer with mixing. The particles were allowed to mix until visual observation confirmed uniform wetting. 15 pounds of the dried microbial product composition from Example 5 were then added. The product was mixed until the coated urea particles were dry to the touch. A photomicrograph of the coated particle is shown in FIG. 2.

c. Diammonium Phosphate

483 pounds of Diammonium Phosphate (DAP 18-46-0 from Prairie Creek Terminal Service, Elwood, Ill.) were loaded into a Continental Rollo-Mixer MK IX, Model No. 31-15/90s (Continental Products Corporation) operating at 90 hertz. The DAP was wetted by spraying-on 2.5 pounds of water via a fine mist sprayer with mixing. The particles were allowed to mix until visual observation confirmed uniform wetting. 15 pounds of the dried microbial product composition from Example 5 were then added to the mixer. The product was mixed until the coated DAP particles were dry to the touch.

### Example 7

### Formulation of Extruded Particles

The following dry mix composition was prepared:

| Ingredient | Level in Dry Mix (kg) |
|---|---|
| Nutri-Pel ® BioSolids ground | 42.63 |
| to particle size less than 200 | |
| microns | |
| Powdered Bentonite Clay | 18.14 |
| Dried mixed microbial | 2.72 |
| composition from Example 5 | |

The individual dry ingredients were mixed in a horizontal mixer for about 30 minutes. The resulting dry mix was then conveyed via an AccuRate screw feed into a Wenger TX52 Twin Screw extruder and water added at the rate of 23.5 kg/hr. The screws were setup in a conveying configuration (low shear, low friction). This produced a moldable, extrudable paste that was pushed through a die having 2 mm openings. The extrudate was cut into 2 mm lengths using a four blade rotating knife. The resulting pellets were collected and conveyed through a forced air, convection drying oven at 35° C. until moisture levels dropped below 20%.

### Example 8

### Respirometry Studies of Coated Biosolids

10 grams of the coated Nutri-Pel® biosolids from Example 6 were added to 300 mls respirometer bottles along with 150 mls of minimal media. The bottles were incubated at 30° C. for 10 days with hourly recording of CO₂ evolution and O₂ consumption using a Micro-Oxymax respirometer:

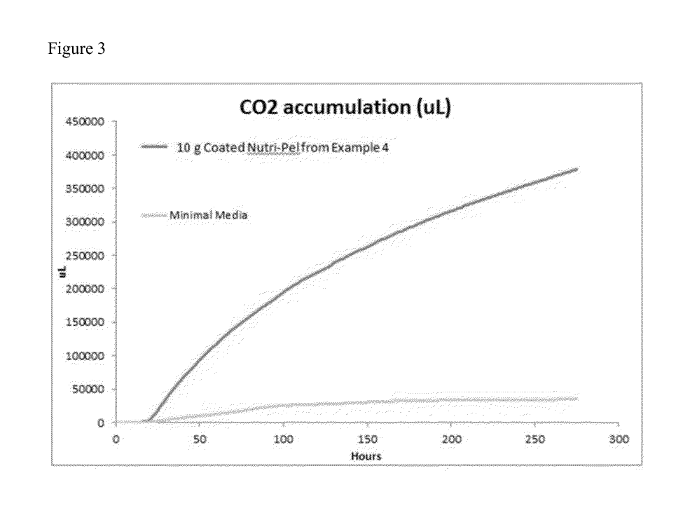

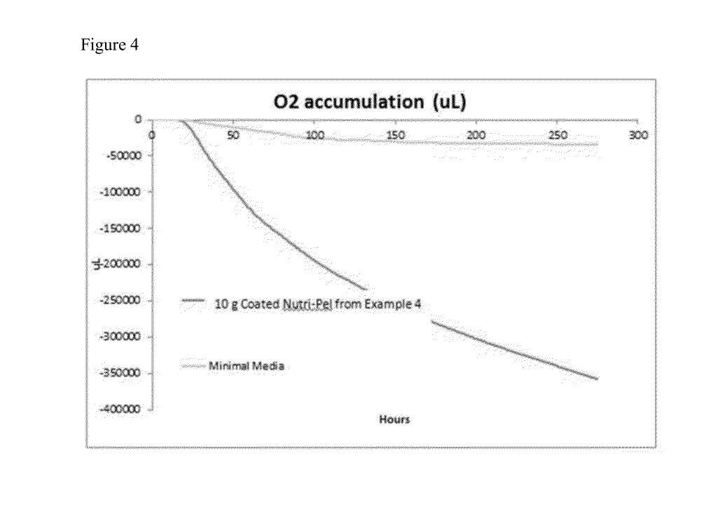

The results (See, FIGS. 3 and 4) demonstrate that the mixed microbial composition can be activated when the coated biosolids are added to an aqueous media.

### Example 9

### Respirometry Studies of Extruded Versus Coated Biosolids

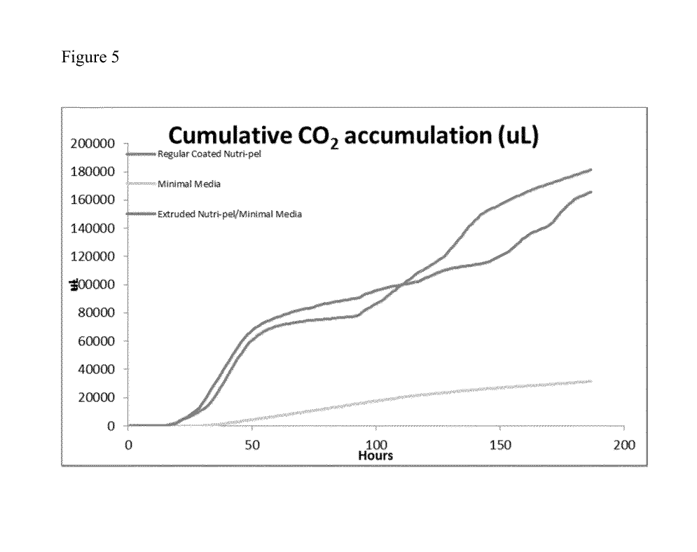

5 grams of the extruded particles from Example 7 were added to a 300 mls respirometry bottle along with 95 mls of minimal media. 5 grams of the coated biosolids particles from Example 6 were added to a separate 300 mls respirometry bottle along with 95 mls of minimal media. The bottles, incubated at 30° C., were connected to the Micro-Oxymax respirometer and CO₂ Evolution and O₂ consumption recorded every hour for 8 days. Results are shown in FIG. 5.

### Example 10

### Activity of Microbes on Coated Urea Particles

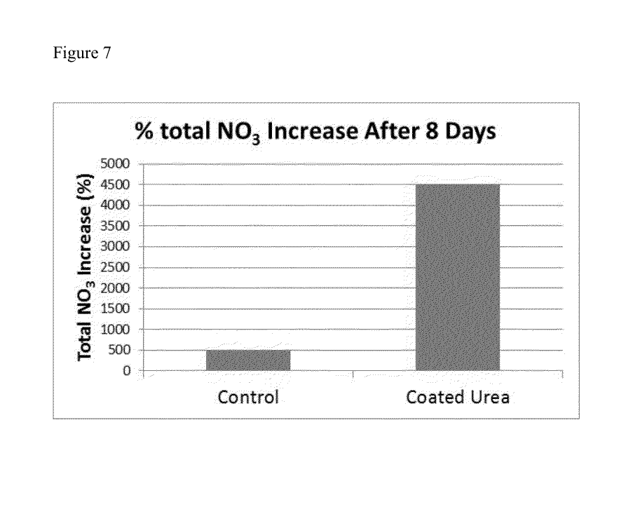

0.15 g of the coated Urea particle from Example 6 was placed in 150 g of topsoil with 15% w/w water. The samples were placed in plastic-lined paper cups with vented covers. The cups were then incubated at 30° C., 100% relative humidity for up to 8 days. Initial nitrate concentrations were measured using ion chromatography (Dionex 240). Samples were collected every 8 hours for the first 48 hours of incubation then every 24 hours until completion of the experiment. Results are in FIG. 7.

Results show significant nitrification from the coated urea sample indicating activity of the mixed microbial system under realistic use conditions. Parallel respirometer studies confirmed significantly higher evolution of CO₂ and consumption of O₂ for the coated urea sample versus the non-microbial control consistent with microbial growth.

### Example 11

### Activity of Liquid and Dry Microbial Mixtures in Soil

The microbial activity assay described in Example 10 was repeated using the liquid and dry mixed microbial cultures from Examples 1 and 2, respectively. In this study the liquid and dry cultures were coated onto Nutripel® biosolids using the protocols described in Examples 3 and 4, respectively. 0.15 g of the coated biosolid particles were placed in 150 g of topsoil with 15% w/w water. The samples were placed in plastic-lined paper cups with vented covers. These cups were incubated at 30° C., 100% relative humidity for up to 5 days. Initial nitrate concentrations were measured using ion chromatography (Dionex 240). Samples were collected every 8 hours for the first 48 hours of incubation then every 24 hours until completion of the experiment.

### Example 12

### Hydroponic Trials with Liquid and Dry Microbial Cultures

The liquid and dry mixed microbial cultures of Examples 1 and 2, respectively, were tested for their ability to increase yield (as measured by plant weight at harvest) of the hydroponically grown lettuce cultivars Fidel, Multileaf, and Red Oak. An NFT hydroponic system was used for this study. The mixed microbial compositions were dosed daily at 10 mg/l according to the following test design:

| Treatment | Dosage | Frequency |
|---|---|---|
| Control | — | — |
| Control + Liquid Microbial | 10 mg/l | Daily |
| Composition of Example 1 | | |
| Control + Dry Microbial | 10 mg/l | Daily |
| Composition of Example 2 | | |
| Control + Commercial mixed | 10 mg/l | Daily |
| microbial product (BiOWiSH ™Crop) | | |

The hydroponic trial was run for four weeks. At the end of the trial the individual lettuce cultivars were harvested and weighed. The effect of the microbial compositions on harvested plant weight, averaged across all three cultivars.

### Example 13

### Expanded Microbial Composition for Agronomy Applications

A composition comprising the bacterial strains from Example 1 and additional microbes selected for their ability to provide additional benefits in agronomy applications is designed using the following protocol:

Individual starter cultures of Bacillus subtilis, Bacillus racemilacticus, Bacillus licheniformis, Bacillus amyloliquefaciens, Bacillus cereus, Bacillus pumilus, Pseudomonas putida, Streptoverticillium griseocarnium, Streptomyces griseoveridis and at least one additional organism selected from the following: Rhizobium phaseoli, Rhiobium leguminosarum, Bacillus azotofixins, Paenibacillus polymyxa, Azobactecter insignis, Arcobacter nitrofigils, Azospirillus lipoferum, or Azospirillum irakense are grown according to the following general protocol: 2 grams Nutrient Broth, 2 grams AmberFerm (yeast extract) and 4 grams Maltodextrin are added to a 250 ml Erlenmeyer flask. 100 mls distilled, deionized water is added and the flask is stirred until all dry ingredients are dissolved. The flask is covered and placed for 30 min in an Autoclave operating at 121° C. and 15 psi. After cooling, the flask is inoculated with lml of one of the pure microbial strains. The flask is sealed and placed on an orbital shaker at 30° C. Cultures are allowed to grow for 3-5 days. This protocol is repeated for each of the microorganisms. In this way, starter cultures of the individual microbial species are prepared.

Larger cultures are prepared by adding 18 grams Nutrient Broth, 18 grams AmberFerm, and 36 grams Maltodextrin to 1 liter flasks with 900 mls distilled, deionized water. The flasks are sealed and sterilized as above. After cooling, 100 mls of the microbial media from the 250 ml Erlenmeyer flasks are added. The 1 liter flasks are sealed, placed on and orbital shaker, and allowed to grow out for another 3-5 days at 30° C.

In the final grow-out phase before introduction to the fermenter, the cultures from the 1 liter flasks are transferred under sterile conditions to sterilized 6 liter vessels and fermentation continued at 30° C. with aeration until stationary phase is reached. The contents of each 6 liter culture flask is transferred to individual fermenters which are also charged with a sterilized growth media made from 1 part yeast extract and 2 parts dextrose. The individual fermenters are run under aerobic conditions at the temperature and pH optimum for each species.

Each fermenter is run until cell density reaches 10¹¹ CFU/ml, on average. The individual fermenters are then emptied into a large, stirred holding tank at 25-27° C. The liquid composition of this holding tank can then be directly applied via spraying to various organic and inorganic fertilizer components as exemplified above. Alternatively, the mixed liquid microbial composition can be filtered, centrifuged, then vacuum dried until moisture drops below 5%. The resulting dried microbial product is then ground to an average particle size of 100 microns. The final microbial activity of the dried, ground product is 10⁹-10¹⁰ CFU/g.

In an alternative procedure the individual liquid fermentations are filtered, centrifuged and vacuum dried until moisture drops below 5%. The resulting dried microbial products are then ground to an average particle size of 100 microns. After grinding the individual dried microbial products are combined in equal proportion to give a final mixed microbial composition with activity between 10⁹ and 10¹⁰ CFU/g.

### Example 14

### Preparation of a Coated Soluble Carrier

Under constant stirring, 3.01 g of the liquid microbial product from Example 1 was sprayed onto 300 g of Sucrose using a fine mist sprayer. After spraying the coated sucrose was allowed to mix for 1 full minute before adding 6.32 g of diatomaceous earth. The final product was a dry, free flowing, water soluble granule with 1×10⁸ CFU/g microbial activity.

### Example 15

### Alternative Preparation of a Coated Soluble Carrier

Under constant stirring, 3.06 g of the liquid microbial product from Example 1 was sprayed onto 300 g of Sucrose using a fine mist sprayer. After spraying the coated sucrose was allowed to mix for 1 full minute before adding 6.02 g of beta cyclodextrin. The final product was a dry, free flowing, water soluble granule with 1×10⁸ CFU/g microbial activity.

We claim:

1. A fertilizer composition having a specified NPK rating comprising a carrier system for delivering a bacterial mix to crops, wherein the carrier system is coated with a bacteria mixture selected from the genus Bacillus, Pseuodomonas, and Streptomyces and wherein the bacteria mixture is coated on the carrier system in an amount between 10⁶ to 10¹¹ colony forming units (CFU) per gram of carrier.

2. The fertilizer composition of claim 1, wherein the Bacillus bacteria are selected from the species Bacillus subtilis, Bacillus racemilacticus, Bacillus licheniformis, Bacillus amyloliquefaciens, Bacillus cereus, and Bacillus pumilus.

3. The fertilizer composition of claim 1, wherein the Pseuodomonas bacteria is Pseudomonas putida.

4. The fertilizer composition of claim 1, Streptomyces bacteria are Streptomyces griseoviridis, and Streptoverticillium griseocarnium.

5. The fertilizer composition of claim 1, wherein the bacteria mixture is Bacillus subtilis, Bacillus racemilacticus, Bacillus licheniformis, Bacillus amyloliquefaciens, Bacillus cereus, Bacillus pumilus Pseudomonas putida, Streptomyces griseoviridis, and Streptoverticillium griseocarnium.

6. The fertilizer composition of claim 5, wherein the ratio of Bacillus to Pseudomonas and Streptomyces is at least 2:1 wt/wt.

7. The fertilizer composition of claim 1, wherein the carrier system is a dried powder, granulate or porous media.

8. The fertilizer composition of claim 7, wherein the dried powder, granulate or porous media has a mean particle size between about 100 and 1000 microns.

9. The fertilizer composition of claim 1, wherein the carrier system is an inert solid.

10. The fertilizer composition of claim 9, wherein the inert solid is filler

11. The fertilizer composition of claim 9, wherein the inert solid is organic or soluble.

12. The fertilizer composition of claim 11, wherein the organic inert solid is rice bran, soy bran, soy meal, soy flour, wheat bran, bone meal, fish meal, or guano.

13. The fertilizer composition of claim 11, wherein the soluble inert carrier is urea, dextrose, DAP, or MAP.

14. The fertilizer composition of claim 7, further comprising a drying agent.

15. The fertilizer composition of claim 14, wherein the drying agent is diatomaceous earth or calcium sulfate, or Zeolite, or Bentonite.

16. The fertilizer composition of claim 1, wherein the composition has an NPK rating of 3-4-0.

17. The fertilizer composition of claim 1, further comprising a dispersing agent.

18. The composition of claim 12, wherein the dispersing agent is calcium lignosulfonate.

19. A method of manufacturing a fertilizer composition comprising, coating a carrier with a bacterial solution comprising a bacteria mixture selected from the genus Bacillus, Pseuodomonas, and Streptomyces to produce a bacteria coated carrier; and drying the coated carrier.

20. The method of claim 19, wherein the bacteria mixture is coated on the carrier in an amount between 10⁶ to 10¹¹ colony forming units (CFU) per gram of carrier.

21. The method of claim 19, wherein the concentration of the bacteria mixture is about 0.001% to 10% (w/w) of the carrier.

22. The method of claim 19, wherein the Bacillus bacteria are selected from the species Bacillus subtilis, Bacillus racemilacticus, Bacillus licheniformis, Bacillus amyloliquefaciens, Bacillus cereus, and Bacillus pumilus.

23. The method of claim 19,wherein the Pseuodomonas bacteria is Pseudomonas putida.

24. The method of claim 19, Streptomyces bacteria are Streptomyces griseoviridis, and Streptoverticillium griseocarnium.

25. The method of claim 19, wherein the bacteria mixture comprises Bacillus subtilis, Bacillus racemilacticus, Bacillus licheniformis, Bacillus amyloliquefaciens, Bacillus cereus, Bacillus pumilus Pseudomonas putida, Streptomyces griseoviridis, and Streptoverticillium griseocarnium.

26. The method of claim 19, wherein the carrier is a dried powder, granulate or porous media.

27. The method of claim 26, wherein the dried powder, granulate or porous media has a mean particle size of between 100 and 1000 microns.

28. The method of claim 19, wherein the carrier is an inert solid.

29. The method of claim 28, wherein the inert solid is filler

30. The method of claim 28, wherein the inert solid is organic or soluble.

31. The method of claim 28, wherein the organic inert solid is rice bran, soy bran, soy meal, soy flour, wheat bran, bone meal, fish meal, or guano.

32. The method of claim 28, wherein the soluble inert carrier is urea, dextrose, DAP, or MAP.

33. The method of claim 19, further comprising coating the bacterial coated carrier with a drying agent prior drying.

34. A method of claim 19, wherein the drying agent is added at a level of 0.1 to 5 wt. % of the substrate.

35. The method of claim 33, wherein the drying agent is diatomaceous earth or calcium sulfate, or Zeolite, or Bentonite.

36. The method of acclaim 19, wherein the carrier has a specific gravity between about 0.3 and 1.5 g/cm³

37. A method for fertilizing crops comprising contacting the crops with the composition of claim 1.

38. The method of claim 37, further comprising mixing the bacterial composition with at least one additional fertilizer ingredient prior to contacting the crops.

39. The method claim 37, wherein the crops are selected from the group rice, corn, soy beans, tomatoes, lettuce, barley, wheat, legumes, and grass.
